(19) United States
(12) Patent Application Publication
(10) Pub. No.: US 2016/0157309 A1
(43) Pub. Date: Jun. 2, 2016

(54) POWER SUPPLY DEVICE OF EMERGENCY LIGHT

(71) Applicant: Bo GENG, Jiangsu (CN)

(72) Inventor: Bo GENG, Jiangsu (CN)

(21) Appl. No.: 14/893,589

(22) PCT Filed: Apr. 12, 2013
(86) PCT No.: PCT/CN2013/074173

§ 371 Date: Nov. 24, 2015

(30) Foreign Application Priority Data
May 29, 2012 (CN) 201210169864.7

(51) Int. Cl. H05B 33/08; H02J 9/06

(52) U.S. Cl. CPC H05B 33/0815; H02J 9/06

(57) ABSTRACT

A power supply device of an emergency light, including: an AC-DC converting module, a charging managing circuit, an emergency battery, a power failure detection circuit and a power failure switching circuit, wherein the input terminal of the AC-DC converting module is connected to a commercial AC power supply via a power switch, the output terminal of the AC-DC converting module is connected respectively to a Light Emitting Diode (LED) lamp and the input terminal of the charging management circuit, the output terminal of the charging management circuit is connected in parallel with the emergency battery, the two input terminals of the power failure detection circuit are connected to the commercial AC power supply via a coupling capacitor, the output terminal of the power failure detection circuit is connected to the input terminal of the power failure switching circuit, the power supply terminal of the power failure switching circuit is connected to the emergency battery, and the output terminal of the power failure switching circuit is connected to the LED lamp. The present invention can be used as an emergency lighting, and also can be used as a normal lighting, without any modification to the current switch and power supply circuitry, enabling a convenient installation and replacement.

### TECHNICAL FIELD OF THE INVENTION

The invention patent relates to a power supply device of an LED emergency light, particularly to a power supply device of LED lighting which can integrate common lighting and emergency lighting.

### TECHNICAL BACKGROUND OF THE INVENTION

The traditional emergency-light power supply has the following solution: when being powered on by the commercial power supply, the emergency-light power supply has been under a standby state. When being powered off, a relay turns on an emergency battery loop to power on the emergency light to light up the emergency light. This emergency light using such the power supply cannot be used as a common lamp, the alternating current of the power supply of the emergency light is converted into the direct current by an AC-DC converter to charge the emergency battery. When being powered off, the relay will turn on the emergency battery to power on the emergency light. This emergency-light power supply has the following several drawbacks:

1: The emergency light of the conventional power supply is only used as the emergency light (that is, the emergency light is lighted up only when the commercial power supply fails), and cannot be used as a common light. From an economic point of view, it is a tremendous waste of resources.

2. Because it cannot be used as the common light, the emergency light of the conventional power supply only can be installed in some public places or sectors, such as airports, railway stations and so on. As for the public places such as the families and communities, it is not applicable.

3. The detection circuit and the switching circuit of the emergency light of the traditional power supply adopt a high energy-consuming device such as the relay, which does not meet the current energy-saving design concept.

### SUMMARY OF THE INVENTION

The purpose of the present invention is directed to the case described above, and proposes a power supply device of an emergency light adopting a power failure detection circuit and a power failure switching circuit. The emergency power supply device only can automatically recognize the state of the turning off of a power switch and the state of powering off of the commercial power supply, without making a malfunction.

The present invention has the following technical solution:

A power supply device of an emergency light includes an AC-DC converting module, a charging managing circuit, an emergency battery, a power failure detection circuit and a power failure switching circuit, wherein the input terminal of the AC-DC converting module is connected to a commercial AC power supply via a power switch, the output terminal of the AC-DC converting module is connected respectively to a Light Emitting Diode (LED) lamp and the input terminal of the charging management circuit, the output terminal of the charging management circuit is connected in parallel with the emergency battery, the two input terminals of the power failure detection circuit are connected to the commercial AC power supply via a coupling capacitor, the output terminal of the power failure circuit is connected to the input terminal of the power failure switching circuit, the power supply terminal of the power failure switching circuit is connected to the emergency battery, and the output terminal of the power failure switching circuit is connected to the LED lamp.

The power failure detection circuit comprises an operational amplifier U3 and elements R40, R42, R39, R38, R41, C20, C21 of the periphery thereof, wherein R40, R42 and R39 constitute an amplification regulation loop, R40 and C20 are connected in parallel and constitute a low-pass filter circuit, a filter circuit consists of R41 and C21, a positive-phase input terminal of the operational amplifier U3 is connected to a firing line of a commercial power supply via a peripheral resistance R38 and a capacitor C14, an inverting input terminal of the operational amplifier U3 is connected to a connection point of R40, R42 and R39 while being connected to the output terminal of U3 via the low-pass filter circuit constituted by R40 and C20 which are connected in parallel, the other terminals of R39 and R42 are connected in parallel and connected with the ground together with a ground terminal while being connected to a null line of a commercial power supply via the peripheral resistance and a coupled capacitor C18, the output terminal of U3 is connected to the input terminal (that is, one terminal of resistance R41) of the filter circuit consisting of R41 and C21, the other terminal of the resistance R41 is connected with the ground after passing through the capacitor C21, the connection point (that is, the filter circuit consisting of R41 and C21) of the resistance R41 and the capacitor C21, as the output terminal of the power failure detection circuit, is connected to the input terminal of the power failure switching circuit. the power failure switching circuit adopts a PMOS transistor Q2, a gate electrode of the PMOS transistor Q2 is connected to the output terminal (that is, the output terminal of the filter circuit consisting of R41 and C21) of the power failure detection circuit, a drain electrode of the PMOS transistor Q0.2 is connected to a positive electrode of the emergency battery, a source electrode of the PMOS transistor Q2 is connected to the LED lamp.

A power supply method of the power supply device of the emergency light comprises steps of:

(a): when being powered on, the input terminal of the operational amplifier U3 is input with a signal of commercial power supply in 50 HZ and 60 HZ, the signal of the commercial power supply passes through the amplification regulation loop constituted by R40, R42 and R39, after the low-pass filter circuit constituted by R40 and C20 which are connected in parallel is amplified and filtered, the output terminal of the operational amplifier U3 outputs a square wave in 50 HZ and 60 HZ, the square wave outputs a 5V high-level direct current via the filter circuit consisting of R41 and C21, the DC signal turns off the power failure switching circuit (that is, the PMOS transistor Q2), that is, the loop constituted by the emergency battery and the LED lamp is turned off, the LED lamp is powered by the commercial power supply;

(b): when being powered off, the input terminal of the operational amplifier U3 is not input with the signal, the output terminal of the filter circuit consisting of R41 and C21 outputs an 0V low-level direct current, the DC signal conducts the power failure switching circuit (that is, the PMOS transistor Q2), that is, the loop constituted by the emergency battery and the LED lamp is connected, the LED lamp is powered by the commercial power supply.

The invention has the following effects:

1. The present invention enables the emergency lighting to be applied to any large-scale lighting application. Without changing the current power supply circuit, the emergency light directly replaces the common light, greatly simplifying the wiring of the emergency light, saving the cost, having high social and economic benefits, saving resources, and easily operating.

2. The power failure detection circuit does not affect the normal power switch circuit, that is to say, the powering-off state of a switch button is not taken as power outage. When there is real powering off, the powering-off signal can be detected in time, and the emergency lighting is initialed, without malfunction and with high availability.

3. The power failure switching circuit of the present invention uses a small energy-efficient P-channel type MOS transistor, rather than high-energy components such as the relay, with an eco-friendly function.

### DRAWINGS OF THE INVENTION

FIG. 1 is an electrical circuit diagram of a power supply device of an emergency light of the invention.

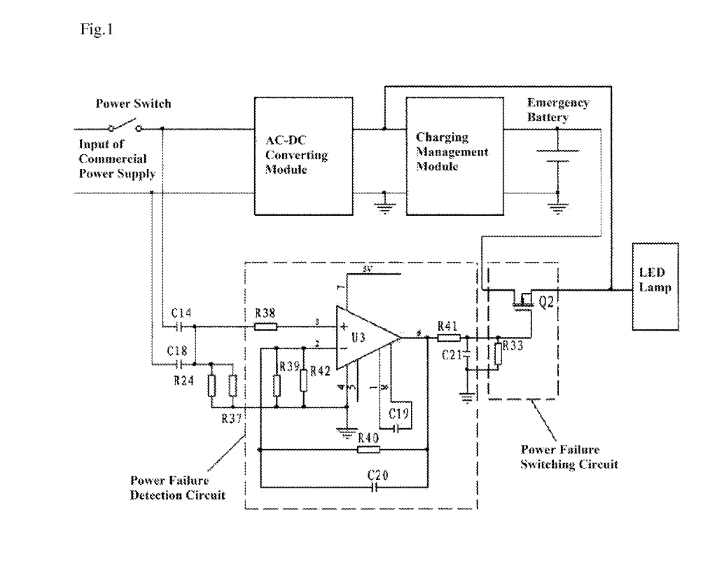

### EMBODIMENTS OF THE INVENTION

The invention is further described with the combination with the drawings.

A power supply device of an emergency light includes an AC-DC converting module, a charging managing circuit, an emergency battery, a power failure detection circuit and a power failure switching circuit, wherein the input terminal of the AC-DC converting module is connected to a commercial AC power supply via a power switch, the output terminal of the AC-DC converting module is connected respectively to a Light Emitting Diode (LED) lamp and the input terminal of the charging management circuit, the module converts the commercial power supply into the direct current, one part of the commercial power supply is used for the LED lamp and the other part is used for charging the emergency battery, the output terminal of the charging management circuit is connected in parallel with the emergency battery, the two input terminals of the power failure detection circuit are connected to the commercial AC power supply via a coupling capacitor, the output terminal of the power failure circuit is connected to the input terminal of the power failure switching circuit, the power supply terminal of the power failure switching circuit is connected to the emergency battery, and the output terminal of the power failure switching circuit is connected to the LED lamp.

A firing ling of the commercial power supply charges the emergency battery via the power switch while being connected to the power failure detection circuit via a voltage 2000V, capacity 2200PF small-capacity high-voltage coupling capacitor C14. As some places without standard electricity consumption passes through the power switch via a null line instead of a firing line, in the present invention, the null line also is connected to the power failure detection circuit via a voltage 2000V, capacity 2200PF small-capacity low-voltage coupling capacitor C18. The power failure detection circuit consists of an operational amplifier U3 with high input impedance and peripheral R40, R42, R39, R41, C20, C21. U3 and the peripheral R40, R42, R39 constitute a noninverting amplifier, the ratio of R40 and R42, R39 is the multiple of the amplifier, the weak signal of the commercial power supply is amplified. R40 and C20 are connected in parallel and constitute a low-pass filter circuit, the high-frequency, non-50 HZ or 60 HZ signal is filtered out. As the magnification multiple of U3 is very high, the output is limited by the voltage of the power supply, therefore, under the conditions of 50 HZ or 60 HZ signal of the commercial power supply, the output terminal of U3 outputs a 50 HZ or 60 HZ square wave. R41 and C21 constitutes one filter circuit to filter a 50 HZ or 50 HZ square wave signal into a DC signal, the DC signal is used for controlling the powering on and the powering off of the PMOS transistor Q2.

Under the conditions that there is commercial power supply, even if the commercial power supply is powered off, there is still a 50 HZ or 60 HZ field signal in the environment, the signal is coupled to the power failure detection circuit via the capacitor. The power failure detection circuit separates out the 50 HZ or 60 HZ signal of the commercial power supply via filtering and amplification. After the amplification and filtering, the output terminal of U3 outputs the 50 HZ or 60 HZ square wave which is filtered by R41, C21 and inverted into DC voltage. The voltage controls a control electrode of the PMOS transistor Q2 and disconnects the loop from the emergency battery to the lamp. The emergency battery does not power on the lamp. The output DC of the AC-DC converting module powers on the lamp. At this time, if the power switch is turned off, the AC-DC converting module does not have output, and the LED lamp does not light up. The power switch is turned on, the AC-DC converting module has output to light up the LED lamp while charging the emergency battery, that is to say, the whole power supply device of the emergency light operates under the normal mode. under the conditions that there is not the signal of the commercial power supply (i.e. power failure), there is not the 50 HZ or 60 HZ electric field signal, U3 outputs low level, the PMOS transistor is conducted to connect the loop consisting of the emergency light and the LED lamp, the LED light lights up, and a system is under the emergency lighting state.

As for the present invention, the AC-DC converting module adopts OB2532, a module charging management circuit adopts YB5056, and a circuit operational amplifier U3 adopts CA3130.

1. A power supply device of an emergency light, the power supply device comprising:
an AC-DC converting module,
a charging management circuit,
an emergency battery,
a power failure detection circuit, and
a power failure switching circuit, wherein
an input terminal of the AC-DC converting module is connected to a commercial AC power supply via a power switch,
an output terminal of the AC-DC converting module is connected to a Light Emitting Diode (LED) lamp and an input terminal of the charging management circuit,
an output terminal of the charging management circuit is connected in parallel with the emergency battery,
two input terminals of the power failure detection circuit are connected to the commercial AC power supply via a-coupling capacitors,
an output terminal of the power failure detection circuit is connected to an input terminal of the power failure switching circuit,
a power supply terminal of the power failure switching circuit is connected to the emergency battery, and
an output terminal of the power failure switching circuit is connected to the LED lamp.

2. The power supply device according to claim 1, wherein the power failure detection circuit comprises an operational amplifier (U3) and elements of the periphery thereof, the elements of the periphery comprising a first element (R40), a second element (R42), a third element (R39), a fourth element (R38), a fifth element (R41), a first capacitor (C20), and a second capacitor (C21), wherein
the first element (R40), the second element (R42), and the third element (R39) constitute an amplification regulation loop,
the first element (R40) and the first capacitor (C20) are connected in parallel and constitute a low-pass filter circuit,
the fifth element (R41) and the second capacitor (C21) constitute a first filter circuit,
a positive-phase input terminal of the operational amplifier (U3) is connected to a firing line of the commercial AC power supply via the fourth element (R38) and a third capacitor (C14),
an inverting input terminal of the operational amplifier (U3) is connected to a connection point of the first element (R40), the second element (R42) and the third element (R39) while being connected to an output terminal of the operational amplifier (U3) via the low-pass filter circuit,
a terminal of the third element (R39) and a terminal of the second element (R42) are connected in parallel and connected with the ground together with a ground terminal while being connected to a null line of the commercial AC power supply via the fourth element (R38) and one of the coupling capacitors,
the output terminal of the operational amplifier (U3) is connected to an input terminal of the first filter circuit,
another terminal of the fifth element (R41) is connected with the ground after passing through the second capacitor (C21), and
a connection point of the fifth element (R41) and the second capacitor (C21), is the output terminal of the power failure detection circuit and is connected to the input terminal of the power failure switching circuit.

3. The power supply device according to claim 1, wherein the power failure switching circuit adopts a PMOS transistor (Q2), wherein
a gate electrode of the PMOS transistor (Q2) is connected to the output terminal of the power failure detection circuit,
a drain electrode of the PMOS transistor (Q2) is connected to a positive electrode of the emergency battery, and
a source electrode of the PMOS transistor (Q2) is connected to the LED lamp.

4. The power supply device according to claim 1, wherein:
(a) when being powered on, the input terminal of the operational amplifier (U3) has an input with a signal of the commercial AC power supply in 50 Hz and 60 Hz,
the signal of the commercial AC power supply passes through the amplification regulation loop, after the low-pass filter circuit is amplified and filtered,
the output terminal of the operational amplifier (U3) outputs a square wave in 50 Hz and 60 Hz,
the square wave outputs a 5V high-level direct current via the first filter circuit,
the 5V high-level direct current turns off the power failure switching circuit such that a loop constituted by the emergency battery and the LED lamp is turned off, and
the LED lamp is powered by the commercial power supply; and
(b) when being powered off,
the input terminal of the operational amplifier (U3) has no input with the signal,
the output terminal of the first filter circuit outputs an 0V low-level direct current,
the 0V low-level direct current conducts the power failure switching circuit such that the loop constituted by the emergency battery and the LED lamp is powered on, and
the LED lamp is powered on by the emergency battery.
